(19) United States
(12) Patent Application Publication
(10) Pub. No.: US 2008/0140491 A1
(43) Pub. Date: Jun. 12, 2008

(54) ADVERTISER BACKED COMPENSATION FOR END USERS

(75) Inventors: Kamal Jain, Bellevue, WA (US); Jody D. Biggs, Redmond, WA (US); Brian Burdick, Bellevue, WA (US); Nishant V. Dani, Redmond, WA (US); Gary W. Flake, Bellevue, WA (US); Marcel Gavriliu, Issahquah, WA (US); Randall F. Kern, Seattle, WA (US); David Lawrence Kiker, Redmond, WA (US); Arun K. Sacheti, Sammamish, WA (US); Brian James Utter, Seattle, WA (US); Polina Veksler, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/768,864

(22) Filed: Jun. 26, 2007

Related U.S. Application Data
(63) Continuation-in-part of application No. 11/625,069, filed on Jan. 19, 2007.
Application No. 11/625,069 is a continuation-in-part of application No. 11/419,896, filed on May 23, 2006.
(60) Provisional application No. 60/764,618, filed on Feb. 2, 2006.

(51) Int. Cl. G06Q 30/00; G06F 17/00; G06Q 10/00

(52) U.S. Cl. 705/8; 705/14; 705/10; 705/7

(57) ABSTRACT

The claimed subject invention presents systems and methods to compensate directly a user of a service platform through advertising spending in exchange for knowledge of the user intent. Advertising spending contributions are allocated to a compensation account that can be accessed by an advertising platform, affiliated with the service platform or not, to compensate users and to update compensation records and transactions with the advertiser. Compensation fraud is actively and reactively mitigated. Compensation of the user is conducted securely and includes compensation points, direct payments and instant rebates, which can be used in transactions with online and offline service platforms. The intent-compensation proposition funded through advertising spending creates a price incentive that differentiates both service platform and advertiser from their competitors, and creates value for user and advertiser.

### CROSS-REFERENCE TO RELATED APPLICATION

This application is a continuation-in-part of U.S. patent application Ser. No. 11/625,069 entitled ALLOCATING REBATE POINTS, filed on Jan. 19, 2007, which is a continuation-in-part of co-pending U.S. patent application Ser. No. 11/419,896, filed May 23, 2006, entitled “AD PUBLISHER PERFORMANCE AND MITIGATION OF CLICK-FRAUD”, which claims the benefit of U.S. Provisional Application Ser. No. 60/764,618, filed Feb. 2, 2006, entitled “A COMPETITIVE PERSPECTIVE ON AD-AUCTION.” This application is also related to co-pending U.S. patent application Ser. Nos. 11/419,881, entitled “EMPLOYING CUSTOMER POINTS TO CONFIRM TRANSACTIONS”, 11/419,802, entitled “MERCHANT RANKINGS IN AD REFERRALS”, 11/419,859, entitled “AD TARGETING AND/OR PRICING BASED ON CUSTOMER BEHAVIOR”, and 11/419,865 entitled “SEARCH ENGINE SEGMENTATION”, all of which were filed on May 23, 2006. The entireties of these applications are incorporated herein by reference.

### TECHNICAL FIELD

The claimed subject matter relates to systems and methods to directly compensate a user of a service platform through advertiser backed funds in exchange for conveying intent of the user regarding use of the service platform.

### BACKGROUND

A “switchboard” service platform acts as intermediary between a user's intent regarding use of the service platform and a service or product. Additionally, such platform can act as intermediary between an advertiser and a user. In typical business models, a switchboard service platform blocks flow of monetary value from the service platform-advertiser to the user-service platform constituent.

In occasions when value flows between constituents, the value is either negligible, which does not benefit the user, or prohibitively expensive for the advertiser, as it does not have access to detailed user profile(s) held by the provider for its own benefit. Lacking detailed user profile(s) also makes it is substantially difficult for an advertiser to offer significant incentives to a user through a switchboard service platform. From a user perspective, the user is limited to selecting a service provider based on an expectation that the service provider would satisfy the user's needs through relevant and competent service.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

System(s) and method(s) as described herein provide for compensating a user of a service platform directly through advertising spending in return for knowledge of user intent. Such direct compensation scheme, referred herein as the advertiser backed compensation (ABC) model, can drive a paradigm shift in the way services are provided. The intent-compensation proposition of the service platform within the ABC model creates a price incentive that differentiates both the service platform and the advertiser from their competitors and it adds value for both user and advertiser.

Value for users of the service platform materializes in compensation that includes compensation points, direct payments and instant rebates that can be used online and offline. Regarding advertisers, in addition to differentiation from competitors, implementation of the ABC model brings at least the following concrete advantages: (i) increase in audience, achieved by “attracting,” rather than “following,” audience through funding the compensation provided by the service platform to its users. Through such compensation the advertiser also builds brand awareness and recognition both online and offline with the ensuing increase in audience; (ii) access to high value audience, as knowledge of the user intent allows the service platform to provide the advertiser with intrinsically high-value audience. Furthermore, through an intent-compensation proposition cycle, the service platform collects valuable intelligence on users, such as personal and socioeconomic information. Such information can be provided to the advertiser in a closed-loop manner with the system to increase the value proposition and implement targeting advertisement and compensation campaigns. Regarding a service platform, in addition to differentiation from competitors, the intent-compensation proposition affords at least the following benefits: (i) gain in user share, as users migrate from service platforms that do not offer compensation to the service platform that compensates its users; and (ii) user and advertiser retention, which can be attained from customization of the offered compensation, as the user gets the service needed in addition to desirable compensation. On the other hand, by presenting advertisers with high-quality audience, advertisers continue to support the intent-compensation proposition of the service platform through advertising spending.

Salient aspects of the systems and methods presented in the subject application are the following. An advertising platform manages advertising spending contributions from an advertiser and directs such contributions toward a compensation account, whose funds are used to compensate a user of a service platform. An allocation process directs a percentage of advertising spending toward the compensation account, and pays a commission to a service platform. The advertising platform can access the compensation account and employ the funds in such account to compensate users of the service platform. Compensation is awarded to users that meet eligibility by conducting commercial transactions with an advertiser in terms delineated by such advertiser, such as purchasing a product, completing a user satisfaction survey, or answering a telemarketer phone call. The advertising platform retains transactions records with advertisers and records of user compensation. Such records can be used to resolve disputes between advertisers and users regarding unpaid compensation. The advertising platform conducts compensation transactions securely, and mitigates fraud actively, by verifying legitimacy of users pursuing compensation, and reactively, by conducting recovery of fraudulent compensation and flagging fraudulent users and advertisers. Through an intent-compensation proposition cycle the advertising platform can collect valuable intelligence on the user, and use it to add value to an advertiser by finding high-value user segments with specific behavior, historical data, or socioeconomic profile, or combinations thereof. To close a customization loop and add value to the user, the service platform can partner with third-party advertising platforms that advertise service and products of particular interest to its users.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and novel features of the claimed subject matter will become apparent from the following detailed description of the claimed subject matter when considered in conjunction with the drawings.

### BRIEF DESCRIPTION OF DRAWINGS

FIG. 1 is a high-level block diagram of a computer system that compensates a user of a service platform in return for the user's intent through advertiser contributions.

FIG. 2 is a high-level block diagram of a computer system that allocates advertising spending to compensate a user of a service platform.

FIG. 3 is a granular block diagram of a computer system that allocates advertising spending to compensate a user of a service platform.

FIG. 4 is a high-level block diagram of a system that compensates a user of a service platform through a third-party advertisement platform.

FIG. 5 is a block diagram of a computer system that collects advertising spending through an intermediary agent to compensate a user.

FIG. 6 is a block diagram of a computer system that gathers intelligence on users and selects an advertiser based at least in part on such intelligence.

FIG. 7 is a block diagram of a computer system that garners intelligence on users and sells it to an advertiser that participates in compensating a user of a service platform.

FIG. 8 is a flowchart of a computer-implemented method for a service platform to compensate a user in return for the user's intent.

FIG. 9 is a flowchart of a computer-implemented method to allocate compensation for a user.

FIG. 10 is a flowchart of a computer-implemented method for a user of a service platform to receive compensation from it.

FIG. 11 is a flowchart of a computer-implemented method to select an advertiser from a pool of advertisers in order to increase value for a user and such advertiser.

FIGS. 12 and 13 illustrate computing environments for carrying out various aspects described herein.

### DETAILED DESCRIPTION OF INVENTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Further, the term “service” can refer to executing a software, such as using a toolbar or web-based email engine; retrieving information (e.g., status of a pending patent application, a proposal submission, immigration process, or package delivery); purchasing goods; making a payment (e.g. mortgage, rent, student loan, credit card, car, phone, utilities, late fees); taking a class at an online school; making an appointment with an offline provider (e.g., dentist, medical doctor, lawyer, hairdresser, mechanic); or registering for an online or offline conference. It should be appreciated that this listing of services is only exemplary.

The term “intelligence” has two meanings: (i) it refers to information that characterizes history or behavior of a person or an entity, and to records of commercial and non-commercial activities involving a product or service, or a combination thereof, of the person or entity; and (ii) it refers to the ability to reason or draw conclusions about, e.g., infer, the current or future state of a system or behavior of a user based on existing information about the system or user. Artificial intelligence (AI) can be employed to identify a specific context or action, or generate a probability distribution of specific states of a system or behavior of a user without human intervention. Artificial intelligence relies on applying advanced mathematical algorithms—e.g., decision trees, neural networks, regression analysis, cluster analysis, genetic algorithm, and reinforced learning—to a set of available data (information) on the system or user.

As described in greater detail infra, a unique commerce model and service platform are described that facilitate optimizing consumer/provider interactions through monetary contributions of advertisers. In particular, mechanisms are described that provide for quickly receiving, soliciting, or gleaning user intent with respect to desired services or goods. Knowledge of such intent provides for service/goods providers to optimize utilization of resources (e.g., bandwidth, advertising, marketing efforts, communications, funds, . . . ) in connection with offering, selling, and provisioning of services/goods. To encourage users to share intent, mechanisms are provided to reward or compensate users for conveying intent. Accordingly, market efficiencies are achieved through service platforms described herein that facilitate utilization of resources and converging on connecting desired customers with desired service/goods providers. Moreover, employment of Internet-based communication schemes provides for dynamic allocation/modification of compensation as a function of supply/demand and achieving and staying at or close to market equilibrium points.

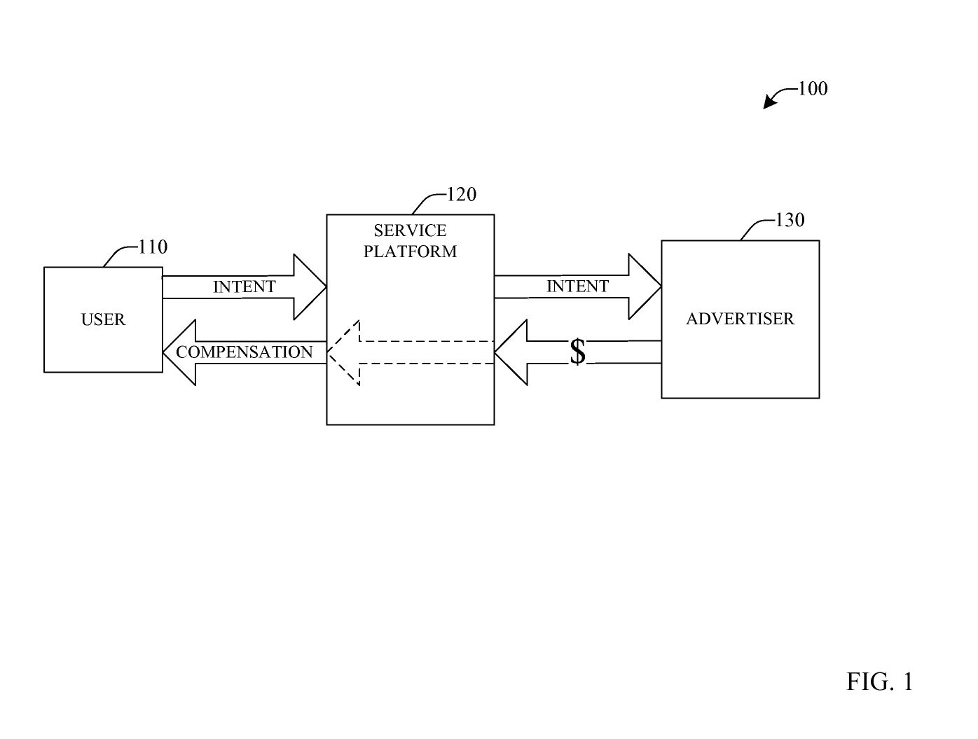

FIG. 1 illustrates a computer system 100 in which a service platform 120 compensates a user 110 in return for knowledge of the user's intent, and sells such intent to an advertiser 130. The compensation in system is backed at least in part by the advertiser through advertising spending paid to the service platform. Such an embodiment illustrates the advertiser backed compensation model claimed in this application. One of the advantages of this concept is that it creates value for the user 110 and the advertiser 130 through the use of the service platform 120.

The service platform 120 acts an intermediary, a “switchboard” that provides a pathway for advertisers to pass their paid search advertising spending through to the user 110. Some or all advertising spending would be redistributed to users in the form of compensation (e.g., compensation points, rebates, direct payments) on engagements with the advertiser, such as purchase of products or services, response to surveys, etc. In an embodiment, the service platform can be an online portal that provides immigration information and an advertiser can be a translation service for a plurality of languages and dialects. The translation service can advertise in the immigration portal, offering rebates on services such as certified translations of documents—e.g., academic credentials such as transcripts and diplomas, birth certificates, and other documents. Within the ABC model, such rebates would be funded through the advertiser's advertising spending. In another embodiment, the service platform can be a search engine. Depending on the search query, an advertiser would present an advertisement offering rebates, which are funded through advertisement spending in the ABC model. The intermediary nature of the search engine is prominent, as it matches a user searching for a product, service, or content with an advertiser whose goal is to offer the same or similar, product, service or content. It should be appreciated that the service platform is neither limited to a specific industry nor a specific service. Exemplary industries are consumer electronics, retail, financial services, media providers, and publishers. It should also be appreciated that a service platform can be an advertiser itself. Desirable characteristics of a service are that the service is primarily consumed through the Internet and used regularly (e.g., on a daily basis).

By compensating the user in return for the user's intent through advertising spending, as is the case within the ABC model illustrated by system 100, the service platform 120 distinguishes itself from competitors by creating a price differential that in turn creates value for the user 110 and advertiser 130. Such value creation provides the service platform with at least the following two prominent advantages: (i) gain in user (market) share—users adopt the service platform by switching from service platforms that do not offer compensation. This transition is based on a long-term behavior change of the user based on a continued compensation program, at an adequate compensation level, facilitated by the service platform. To accelerate adoption and promote user excitement, the service platform can “prime the pump” by matching advertisers' compensation levels. (ii) User retention—users that are compensated for their intent tend to remain loyal to the service platform that provides such compensation. As an example, airlines (an offline service) have pioneered the exploitation of the loyalty-compensation scheme through frequent-flyer programs. In another example, the segment of users that employ searches as the primary tool in their online purchases are the ones that benefit the most in such a compensation-based search platform; thus, such users are expected to be the most loyal to the service platform. However, user retention is dynamic and depends strongly on competitor response. Namely, users migrate among service platforms seeking the most advantageous compensation scheme. Therefore, to attain sustained user retention, continued differentiation is required from the service platform. Securing a plurality of advertisers highly interested in the ABC model enhances the intrinsic retention potential of differentiation. For this reason, a direct compensation program provided by a service platform, based at least in part on advertising spending, can drive a paradigm shift in the way services are provided and advertisers are billed.

As stated above, the ABC model (illustrated with system 100) also creates value for the advertiser 130. The value created for the advertisers is initially latent or locked, but it unlocks as the advertiser adopts the ABC model and actively directs advertising spending towards compensating users. The advertiser 130 receives value when more users transact with the advertiser in exchange for the compensation—an increased value proposition of the service platform-advertiser pair. It should be appreciated that the increased value proposition does not necessarily cannibalize profits. Namely, if advertiser migrates from a high take rate/high price service platform to a less expensive service platform 120 operating within the ABC model, the advertiser can offer compensation at the same level of profitability.

The ABC model provides the advertiser 130 with at least the following advantages: (i) increase in audience—the advertiser has the ability to “attract” incremental audience through compensation rather than “follow” the audience by displaying advertisements. In addition, through compensation the advertiser also builds brand awareness and recognition both online and offline, with the ensuing increase in audience. Moreover, attracting audience helps increase sales volume. This, for example, is critical to the profitability of companies in fixed-cost industries. Moreover, an increased audience can help increase offline traffic. (ii) Access to high value audience—as intent of the user is known, the service platform provides high-value audience. The user's intent reveals the purpose of accessing the service platform and constitutes the key to receiving a service from it. The user discloses intent based on an expectation that the service platform would be relevant to the user's needs. Thus, advertisers can target adds with adequate compensation levels. High-value audience is good for companies that belong to variable-cost industries, such as contracting enterprises (e.g., consulting, construction, landscaping). It should be appreciated that the companies or service providers that are advertised can have operations exclusively offline and still take advantage of the high-quality audience that is accessed through the service platform 120. As an example, consider an embodiment in which the advertiser is a landscaping company and the service platform is the online portal of a gardening retailer. By offering coupons (compensation) on high-margin jobs, the offline landscaping company can increase profitability without relying on high contracts volume. (iii) Differentiation from competitors. This advantage originates in the increased value proposition created by compensating a user in return for the user's intent. (iv) Disintermediation of online retailers. By providing compensation through an online service platform, producers that advertise their products can directly compensate a user; thus, making an intermediary retailer unnecessary.

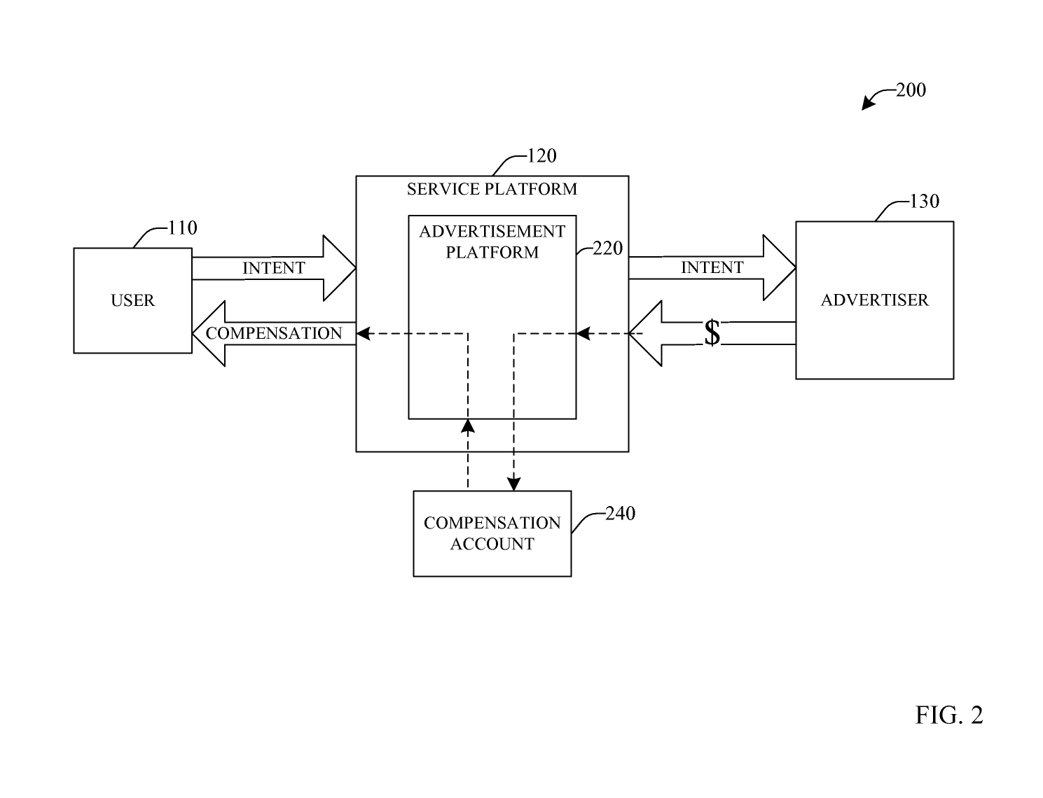

FIG. 2 illustrates a computer system 200 that allocates advertising spending to compensate users of a service platform. The system comprises an advertisement platform 220 and a compensation account 240. The advertiser 130 receives user's intent from the service platform 120 in exchange for advertising spending. The service platform transfers advertising spending to the advertisement platform, which in turn allocates advertising spending into the compensation account 240. In system 200, the service platform hosts the advertisement platform 220. When a user is compensated, the compensation account 240 transfers the compensation through the advertisement platform 220. A user is compensated when an eligible action, predetermined by the advertiser 130, is completed through the service platform. In one aspect, the compensation to the user can take the form of an instant rebate at the time of conducting a purchase. In another aspect, the compensation can take the form of compensation points or a direct payment. Advertising spending backs at least these three forms of compensation. But, as stated above, the service platform can also pay for a fraction of the compensation.

User intent can be obtained in a variety of manners such as for example, explicit expression of user intent, implicit expression, determined or inferred user intent. Moreover, a variety of instruments or mechanisms can be employed to obtain user intent (e.g., portals, pop-up windows, queries, statements, utterances, inferences, extrinsic evidence, historical data, machine learning systems, etc.). Veracity of the user intent as well as confidence measures associated therewith can also be calculated or factored in connection with allocation of compensation and advertising spending toward compensation.

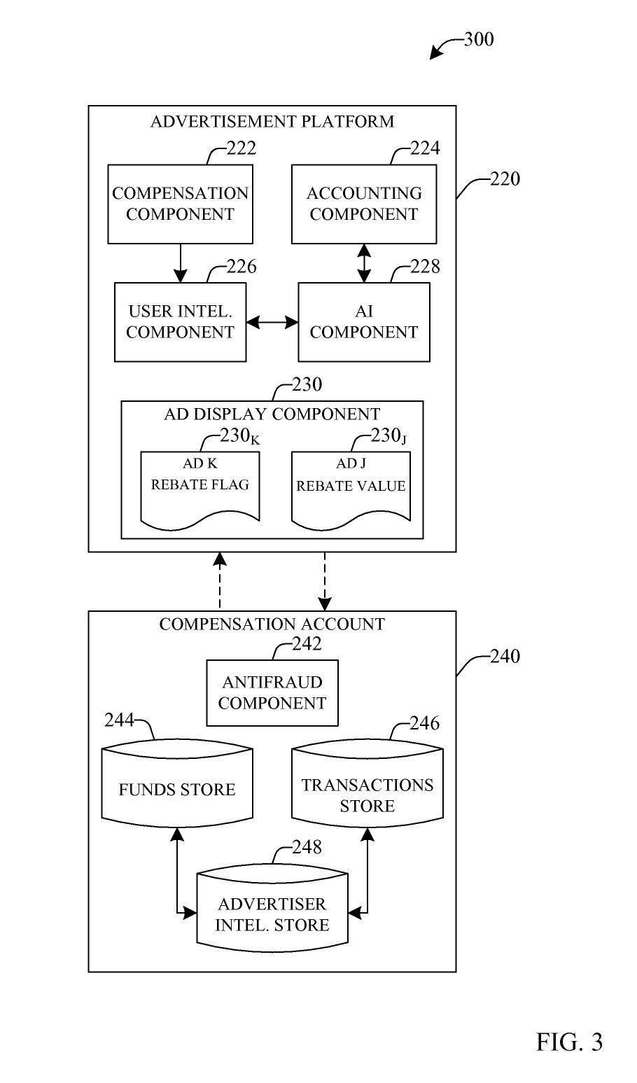

FIG. 3 illustrates the architecture of the advertisement platform 220 and the compensation account 240 in accordance with a particular embodiment. In such embodiment, the advertisement platform 220 comprises five components: (a) compensation component 222; (b) accounting component 224; (c) user intelligence component 226; (d) an optional learning and reasoning system, referred to as artificial intelligence component 228; and (e) advertisement display component 230. The functionality of such components, as well as exemplary aspects of their operation is discussed next.

The compensation component 222 issues compensation to a user according eligibility criteria imposed by the advertiser 130 and the service platform 120. As stated above, the advertiser determines actions that are eligible for compensation. Such actions include, but are not limited to, trying or purchasing a new product or service, or providing feedback to the advertiser 130 or the service platform 120 (e.g., responding to an online survey, engaging in an online chat with a marketing specialist, answering a phone call from a telemarketer). The service platform 120 can elect to provide compensation only to registered users of a service. Thus, users that are not registered can be offered to try the ABC program for a limited period of time, or can be allowed to receive a one-time compensation based at least on a random selection. Moreover, the service platform can base eligibility for example on various metrics (e.g., age, sex, demographics, profiles, historical buying behavior, income level, occupation, reliability, etc.) that facilitate distinguishing desirable candidates from less desirable ones (e.g., spammers, children, individuals with bad credit . . . ). It is to be appreciated that rewards/incentives can likewise be dynamically tailored as a function of eligibility. For example, repeat high value customers may receive greater rewards than prospective new customers that have low probability of repeat business.

The compensation component 222 can also prompt users to provide an advertiser rating. The compensation component 222 also records compensation transactions, and informs users of the compensation level obtained in the transaction and indicates that such compensation is possible due to the ABC program implemented through the service platform 120. Maintaining records of compensations provides a way to resolve disputes that can arise from users claiming an eligible uncompensated transaction with an advertiser. In a dispute, the advertisement platform 220 can either directly refund the user, or start an audit of the transaction to confirm its veracity. Having an audit confirm that the advertiser did not compensate a user in an eligible transaction can reflect negatively in the advertiser's rating, or can prompt the service platform to severe the advertiser from the ABC program. Records are then passed on to the accounting component 224, and the advertiser rating to the advertiser intelligence store 248 in the compensation account 240.

In one aspect, the compensation component 222 prompts users to select what type of compensation is to be issued: compensation points, a direct payment, or instant rebate, or a combination thereof. Upon making a selection, the compensation component accesses the compensation account 240 and delivers the compensation. Intelligence on the user such as amount of compensation received, eligible transaction with advertiser, and advertiser identification, are collected and passed on to the intelligence component 226. It should be appreciated that when the user selects compensation points and direct payments, both of these can be saved in a compensation account established for the user for future use. Moreover, such type of compensation can be used with the same advertiser or a different advertiser, especially in case of a direct payment which is a money instrument. In order to use points with a plurality of advertisers' products or services the compensation component can issue generic points instead of specific points associated with a specific advertiser. A user obtains generic points depending on criteria specified by the service platform. On the other hand, when users select an instant rebate, the compensation can be issued by the advertiser itself instead of the compensation component 222. Such scenario allows the advertiser to refrain from disclosing to the advertisement platform 220 or service platform 120 the actual magnitude of the rebates. In addition, records of the transaction can also be kept at the advertiser end.

The accounting component 224 collects advertising spending from the advertiser and “funnels” it into the compensation account 240. Funds stored in the compensation account (in the funds store 244) are based at least in part on a pre-determined (compensation allocation) percentage p of advertising spending. In one aspect, the advertisement platform 220 pays a commission to the service platform 120 out of the remaining (100%−p) advertising spending. The percentage p is time dependent, and its magnitude can be determined at least in part as a function of advertiser's rating (developed over time through user feedback; see above), advertiser industry, e.g. fixed-cost or variable-cost industry, advertisement quality, or advertiser's level of advertising spending. It should be appreciated that other factors can be included on the determination of p. In addition, as stated above, p can be matched up by the service platform 120. The extent of the matching can be determined based at least in part on the user that is being compensated, the advertiser, or a combination thereof.

Once funds have been funneled to the compensation account 240 the accounting component 224 “locks” those funds (in the funds store 244) until the advertiser exceeds advertising spending. As an example, suppose an online advertising platform has adopted the ABC model and has a cost per click (CPC) of $1 and a compensation allocation percentage p=5%. Further, suppose that after a billing cycle an advertiser is billed $20. If the advertiser pays $20, the accounting component funnels $1 to the compensation account on behalf of the advertiser. The remaining $19 is put toward the invoiced amount, and the $1 in compensation funds is locked in. In order to unlock the $1 for compensation purposes, the advertiser needed to pay $21. Otherwise, at the end of the advertiser lifetime, funds in the compensation account 240 would be taken to cover deficits in invoice payments, and the advertiser would not benefit from having joined the ABC program. Thus, to have access to a fixed stream of unlocked compensation funds, the advertiser needs establish an advertising budget through modeling of its advertising expenses over a number of cycles, and subsequently make payments to the advertising platform that on average exceed advertising spending. The advertiser can choose to make fixed payments that correspond to 5% above the average of the highest invoice and lowest invoice over a determined number of cycles, such that over the said number of cycles the advertiser can expect to have compensation funds that correspond to 5% of the advertising spending over the period spanning the said number cycles. Or, the advertiser can make variable payments such that 5% of the total spending is available in the same period.

Funds in the compensation account available to an advertiser can also arise from credit provided by the service platform 120. The level of credit depends at least in part on historical levels of compensation of the advertiser in a predetermined period of time, for an existing advertiser, or advertiser industry for a new advertiser joining the ABC program. Advertisers pay back the credited funds through payments that exceed advertising spending. Crediting the compensation account is a bootstrap mechanism for the service platform or advertisement platform to ensure that users will be compensated in each eligible transaction with the service or advertisement platform. Consistently unavailable compensations can result in user migration to other platforms and brand deterioration, which can be costly to repair. It should be appreciated that “funds” can be compensation points or monetary instruments (such as credit card credit, stocks, certificates of deposit, etc.) available for instant rebates or direct payments. In the case of compensation points, a conversion from monies (e.g., advertising spending) is performed according to a conversion rate predetermined by the service platform or the advertiser, or both.

The accounting component 222 also manages an advertiser's funds that exceed advertising spending. Excess funds can be allocated to the advertiser for future advertising, or can be allocated toward future user compensation and stored in the compensation account 240, or a combination thereof. By accessing the compensation account (e.g. via secure remote login), advertisers can review or customize an allocation of funds. In an aspect, an advertiser can only reallocate rebate funds toward advertising spending, with the converse reallocation having to be reviewed and approved by the service platform 120 or advertising platform 220. The algorithm allocating the excess funds can reside in artificial intelligence component 228 and use at least in part intelligence available on the user and the advertiser (e.g., advertising strategy, advertiser industry, volume of rebates extended in the past, advertising rating, advertisement quality, etc.). As an example, an advertiser of a new product or service would require a more aggressive allocation toward user compensation rather than future advertising, as the product can experience a weak market penetration and future advertisement cannot be warranted. The funds stored in the compensation account can be perishable or perennial, depending at least in part on the advertiser, advertiser industry, or a combination thereof. To identify funds as perennial or perishable, such funds can be embedded with a token component, which can be encrypted and contains type of funds and expiration date in case of perishable funds. Perishable funds in the compensation account that are beyond their expiration date become unclaimed funds. The accounting component 224 notifies the service platform of such funds. The service or the advertisement platform can use unclaimed funds to (a) attract new users or reward loyal users; (b) gain or improve brand recognition and awareness online and offline by promoting the service platform or advertisement platform through advertising and sponsoring of events and entities; or (c) finance the compensation account 240 toward compensation originating from selected advertisers in selected industries in order to retain or attract such advertisers. It should be appreciated that such list of uses for unclaimed funds is exemplary, and other choices as to how to use unclaimed funds are possible.

Additionally, the accounting component 224 updates the compensation account after compensation to a user has been issued by the compensation component 222. The accounting component also retains records of advertiser transactions in the advertiser transactions store 246. It should be appreciated that advertiser transactions correspond to transaction between the advertiser 130 and the advertisement platform 220. Such a transaction can be negotiation of advertisement costs, payment of advertising spending, disputes of wrongfully compensated users, or enrollment in the ABC program. In accordance to a particular embodiment, intelligence on advertisers is stored in the compensation account 240 within an advertiser intelligence store 248. Such store can contain a record of audits that the service platform 120 applied to the advertiser.

Access to the compensation account and information contained therein (e.g., advertisers records) is secured by an antifraud component 242 which can use, for example, various techniques such as password- and biometric-protected access and encryption, as well as widespread techniques to protect financial information. In addition to securing the contents of, and access to, the compensation account 240, the antifraud component 242 prevents fraudulent and illegitimate compensation. In one aspect, fraud mitigation can be (i) active or (ii) reactive. Active mitigation concerns preventing compensation by users that are not registered to participate in the ABC program, or registered users that intend to game the compensation component 222 with a software script that access the service platform to claim compensation, with no legitimate intent. As a tool of active mitigation of fraud, a registered user can be assigned a token component, which can be encrypted, that confirms registration and contains characteristic intelligence on the user (e.g., personal information, configuration of system used to access service platform, etc.). Reactive mitigation regards recovery of fraudulent or illegitimate compensation. As an example, a user buying an accessory for a car (e.g., digital radio receiver, smart windows, etc.) agrees to respond within a predetermined period of time to a survey regarding performance of such accessory in return for a discount, and takes the compensation but does not respond to the survey in the allotted time. The antifraud component thus pursues recovery of the compensation or, depending on the user, reminds him/her to complete the survey before compensation collection procedures begin. It should be appreciated that fraud incidents can prompt the antifraud component 242 to generate a fraud report and rating for a fraudulent user, which can be used by the compensation component 222 when issuing compensation for such user in order to punitively adjust an issued level of compensation.

Referring to the advertisement display component 230, such displays a plurality of advertisements to a user 110 of a service platform 120. The advertisements can present a compensation flag (e.g., 230K) or an exact-rebate-value (e.g., 230J) flag. Advertisements can be image-based (e.g., banners) or text-based. In one embodiment, the display component can be used to remind the user of advertised compensation after the user is no longer using the service platform. In such embodiment, the display component sends advertisements that were previously presented to the user to an electronic device, portable or otherwise, with a display area that the user can access, interactively or otherwise. Such embodiment adds value for the service platform and the advertiser as it increases the lock-in of the user with the service platform by increasing the likelihood of repeat engagements, in which new advertisements can be presented to the user. In accordance with an aspect of such embodiment, click rate in an online advertising campaign can increase. The service platform 120 can request the user to register the device employed for this “reminder” service. Such registration increases the wealth of intelligence on the user, which in turn can be used to match the user with advertisers of products/services for such device.

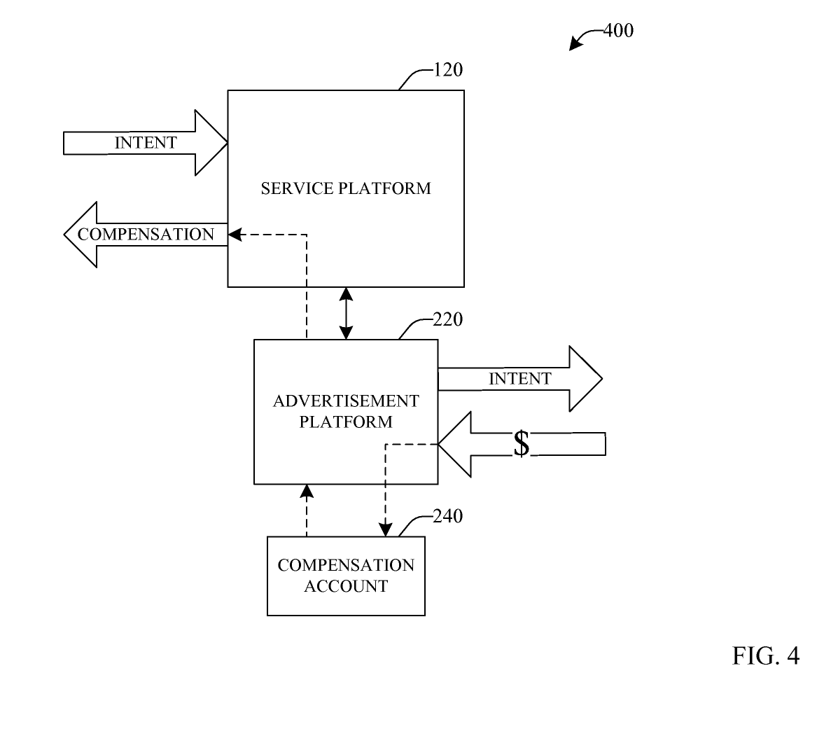

FIG. 4 depicts computer system 400 that compensates a user of a service platform through a third-party advertisement platform. System 400 allows the service platform 120 to access specific advertiser segments by targeting specific advertising platforms for partnership (see below). Such system is an additional or alternative embodiment to system 200 in that the service platform does not host the advertisement platform. System 400 allows cross-platform compensation. Namely, a service platform receives and processes the intent of a user, and a disparate advertisement platform display advertisements with compensation opportunities to such user. User receives compensation through the service platform 120 upon an eligible transaction with the advertiser. Such cross-platform compensation is suitable for, but not limited to, offline compensation through online advertising. The following exemplary aspects illustrate cross-platform compensation. (i) A user buys a product at an electronics store (offline venue), at checkout the product is scanned for pricing, at such time an online advertisement platform is sent a electronic “ping,” subsequently an advertisement with a rebate related to the product is displayed to the user. The advertisement is displayed in either the checkout station, an electronic device the user has access to (as discussed above), or the product itself. The latter can be accomplished, for example, by using a thin-film flexible display coated on the product packaging. The user can then transact with the advertiser, e.g., the user agrees to reply to an online survey about the product within a predetermined period of time or agrees to buy a second unit of the same product, in return for a discount on the product. The discount is facilitated by the electronics store, which bills the advertiser afterward for the discount. (ii) A user buys a country music CD from a specific record label at a store, at the time of checkout an online advertiser sends advertisements presenting CDs of other country artists that are being promoted by the record label. The advertisements are displayed in the CD (e.g., using flexible display technology). If the user transacts with the advertiser by following the advertisement to receive a code to a discount, the store processes the discount and then bills the label record. It should be appreciated that other embodiments are possible to compensate the user in offline transactions, such as those in an automated-teller-machine (ATM) banking, where an advertising platform waves the out-of-network usage fee assessed by the ATM owner.

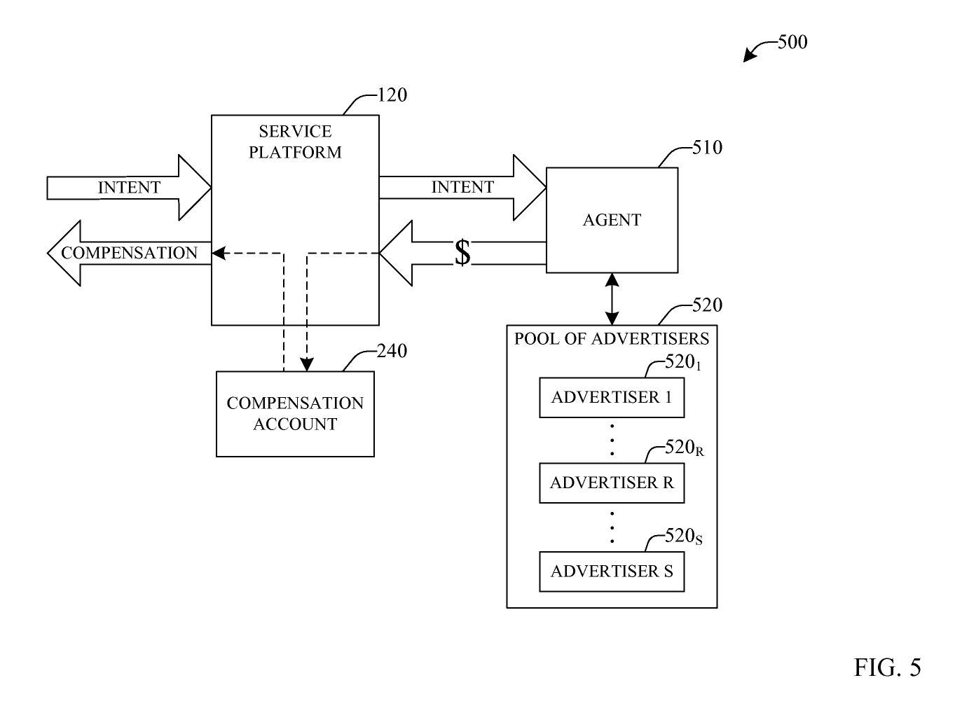

FIG. 5 illustrates a computer system 500 that collects advertising spending through an intermediary agent to compensate a user. Agent 510 manages the advertising needs of a pool of advertisers 520 (e.g., 5201-520S) who pay advertising spending to such agent in order to conduct an advertising campaign with specific priorities—e.g., a target a specific segment of an online market, breaking into a specific market, collecting behavioral intelligence on users. Agent 510 partners with the service platform and adopts the ABC model. By adopting the ABC model, the agent accesses a high-value audience for its clients and differentiates them from their competitors. By adopting the ABC model, agent 510 also differentiates from other agents. Thus, such agent contributes to the compensation account 240 based at least in part on advertisers needs. The contribution of agent 510 can arise at least in part from advertising spending paid to the agent by advertisers 5201-520S or the agent's own revenue. Due to the intermediary nature of agent 510, it can be a driver of adoption of the ABC program by a variety of advertisers. As stated above, to accelerate adoption and gain market share, the service platform 120 can subsidize the agent's contributions toward the compensation account. Because the agent has access to a plurality of advertiser segments, the agent can identify advertisers who can profit substantially from adopting the ABC model. In addition, agent 510 has access to valuable advertiser intelligence, which can be exchanged for subsidies toward the compensation pool in its favor.

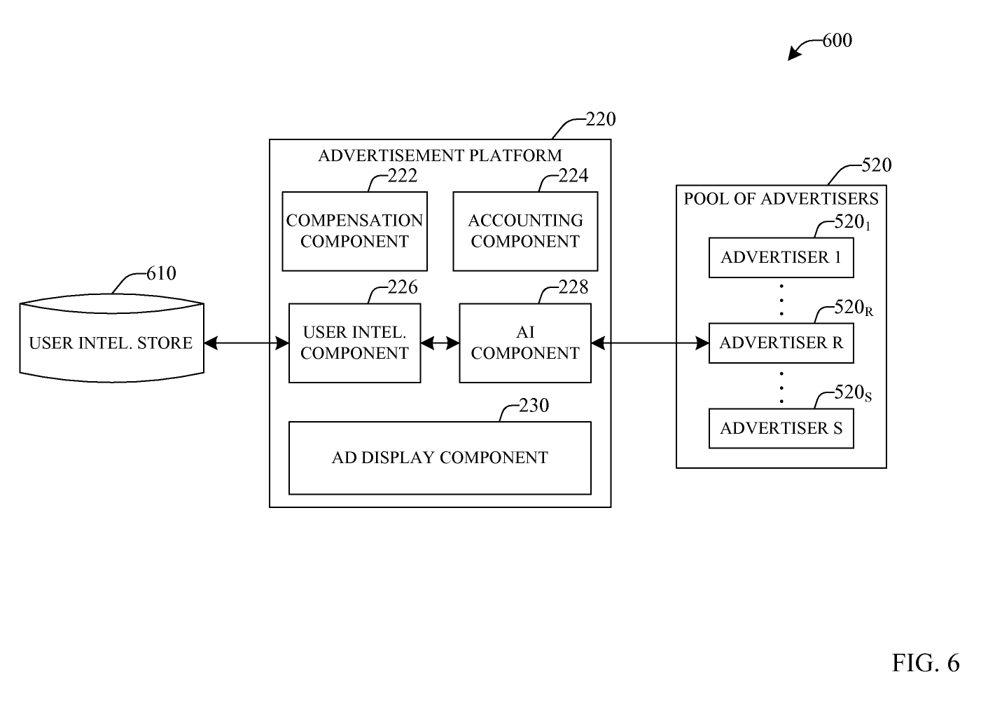

FIG. 6 illustrates a computer system 600 that gathers intelligence on users and selects an advertiser based at least in part on such intelligence. System 600 illustrates a virtuous harvesting cycle of users and advertisers: An advertiser is presented with top-quality audience, such leads to increased value for the advertiser with the ensuing increase in retention and adoption of the ABC model, which in turn results in added value for the user. In one aspect, the advertising platform 220 accesses user intelligence store 610 and uses artificial intelligence component 228 to segment the users according to a variety of personal or socioeconomic data, or a combination thereof. User intelligence store 610 complements the intelligence collected by the user intelligence component 226, and it can belong to an affiliate or partner advertising or service platform. Artificial intelligence component 228 identifies one or more suitable advertisers (e.g., Advertiser R) for each of the user segments previously identified. It should be appreciated that users whose information is stored in the user intelligence store 610 may not be users of a service platform (not shown). In such case, the advertising platform can identify, through the AI component 228, suitable (online or offline) service platforms that can provide desirable services for those users. The advertising platform can also allocate funds in a compensation account towards advertisers that adopt the ABC model as a consequence of the subject AI-based user harvesting.

The AI component 228 can be employed in connection with making determinations or inferences regarding optimization decisions and the like. The AI component 228 can employ a probabilistic-based or statistical-based approach, for example, in connection with making determinations or inferences. The inferences can be based in part upon explicit training of classifier(s) (not shown) before employing the system 100, or implicit training based at least upon a user's, provider's, or advertiser's previous actions, commands, instructions, and the like during use of the system. Data or policies used in optimizations can be collected from specific users or services/goods providers or advertisers or from a community of users, providers, and advertisers.

The AI component 228 can employ one of numerous methodologies for learning from data and then drawing inferences from the models so constructed (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein.

Methods also include methods for capture of logical relationships such as theorem provers or more heuristic rule-based expert systems. Inferences derived from such learned or manually constructed models can be employed in optimization techniques, such as linear and non-linear programming, that seek to maximize some objective function. For example, maximizing the overall efficiency of determining or inferring user intent, identifying prospective and relevant services/goods providers and advertisers, dynamically calculating, or conveying compensation/incentives as well as associated bi-directional filtering to optimize data consumption, resource utilization, optimizing return on investment (ROI), and the like.

The optimization policies can take into consideration inferences about user intent, goals, uncertainty, sporadic behavior, point of sale, inventory, time to delivery, quality, ratings, rankings, reputation, authenticity, reliability, and other factors that are considered in connection with commercial transactions, for example.

The AI component 228, can take into consideration historical data, and data about the current context (users, providers, or advertisers). Policies can be employed that consider including consideration of the cost of making an incorrect determination or inference versus benefit of making a correct determination or inference. Accordingly, an expected-utility-based analysis can be used to provide inputs or hints to other components or for taking automated action directly. Ranking and confidence measures can be calculated and employed in connection with such analysis.

For example, the cost of making an incorrect decision regarding offering compensation to a particular set of prospective users given cost of doing so, available provider resources and monies versus expected ROI can be factored into decisions as part of the optimization process.

Policies can be employed that optimize compensation/incentive utilization as well as cost thereof. In view of the foregoing example, it will be appreciated that optimization is dynamic and policies selected and implemented will vary as a function of the numerous parameters (e.g., supply/demand, user/advertiser state, user/advertiser goals, user/advertiser preferences, costs, efficiency, available time, schedules, environment, inventory, workflow, advertising or compensation budget, price points, equilibrium points, market saturation levels, expected future demand, backlogs, trends, fads, dumping strategies, competitor analysis, user and provider tolerance levels, risk analysis, . . . ); and thus the AI component 228 is adaptive.

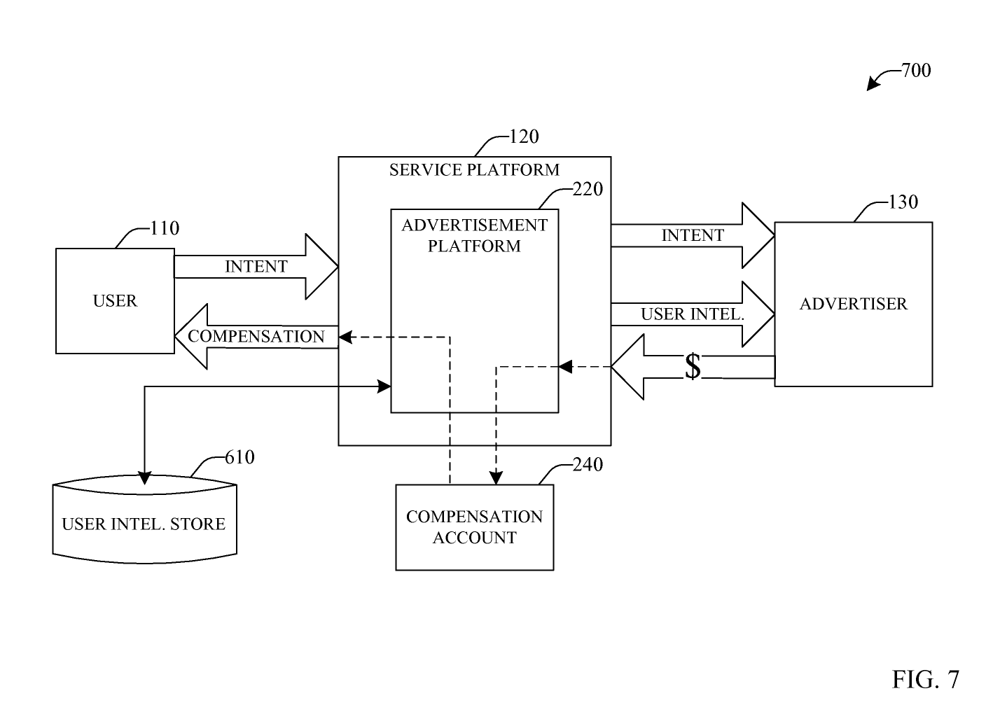

FIG. 7 illustrates a computer system 700 that garners user intelligence and sells it to an advertiser that participates in compensating a user of a service platform. Advertising platform 220 collects user intelligence stored in a user intelligence store 610. The user intelligence is analyzed and categorized according at least to behavioral patterns, socioeconomic and historical data. The advertisement platform 220 sells the user intelligence of interest or relevant to the advertiser through the service platform 120. In one aspect, an artificial intelligence component (e.g., AI component 228) analyzes the user intelligence, focusing on patterns that can be targeted by the advertiser in an advertising campaign. In another aspect, the revenue from such sale can be directed by service platform 120 or advertising platform 220 toward subsidizing the compensation account 240. It should be appreciated that other uses of such revenue are possible.

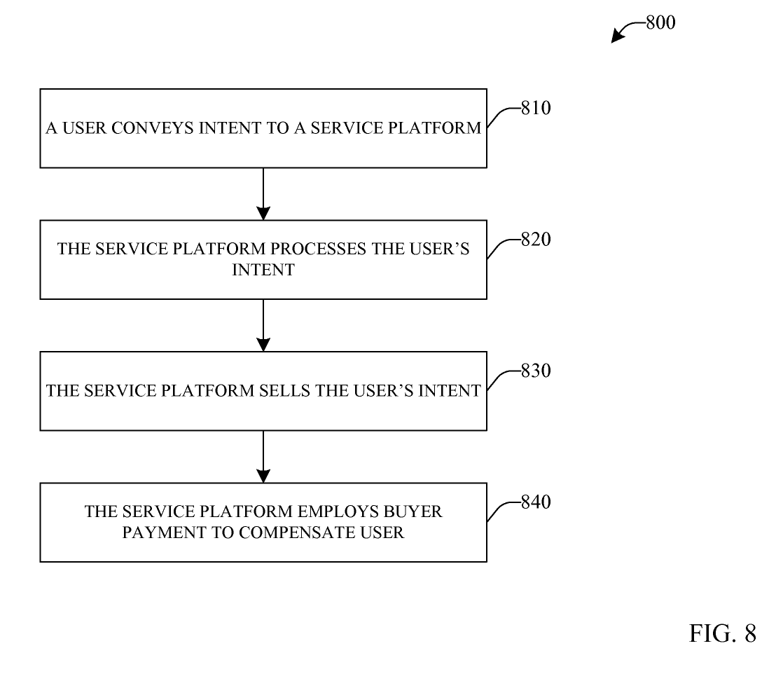

FIGS. 8-11 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers.

FIG. 8 presents a computer-implemented method 800 that facilitates compensation of users of a service platform through advertising spending in exchange for the user's intent. At 810 user conveys intent to a service platform. The intent constitutes the key to receive a specific service from the service platform. Thus, the user discloses intent based on an expectation that the provider would satisfy the user's needs through relevant service. At 820, the service platform analyzes and processes the user's intent to provide the user with a service. The service platform then sells the user's intent in act 830. In accordance to a particular embodiment, the intelligence is sold to an advertiser (130, FIG. 1). To the advertiser, knowledge of the user's intent facilitates targeting of advertisement products, which can result in an increased return-on-investment when buying advertising space from the service platform. Thus, user's intent has an intrinsic monetary value to the advertiser. In another embodiment, intelligence on the user can be sold to, or exchanged for content with, a third-party service provider. Such provider can also use such intelligence for customizing service delivery and targeting advertising campaigns. At 840 the service platform employs at least a portion of the buyer's payment to compensate the user. In one aspect, compensation can be implemented as discussed above (FIGS. 1-3).

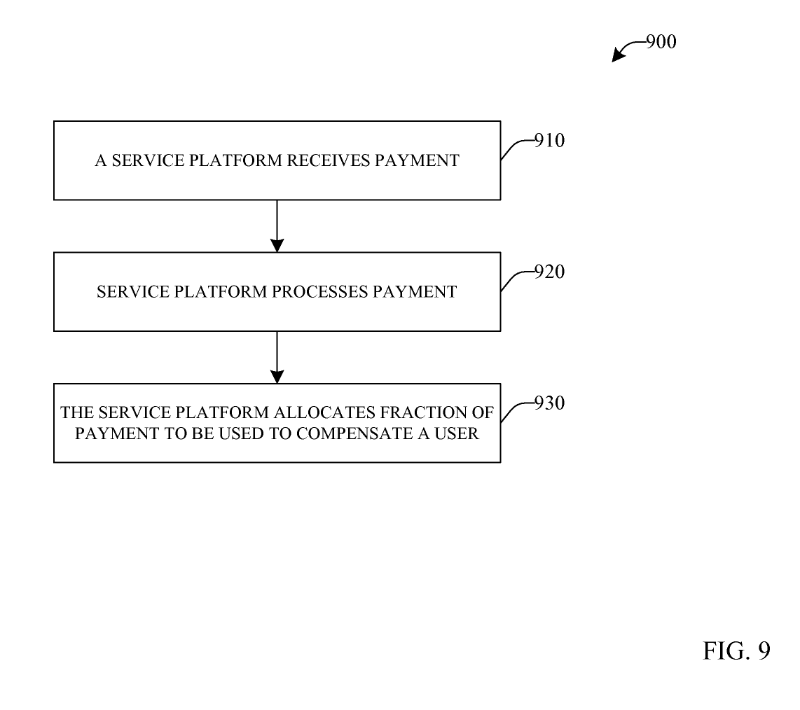

FIG. 9 illustrates a computer-implemented method 900 to allocate compensation for a user of a service platform. Act 910 of the method consists of the service platform receiving a payment. Such payment can be advertising spending from an advertiser, or fees collected from users in exchange for a service provided (e.g., subscription to online content, mortgage or rent payment, or pay-roll processing for a third party enterprise.) At 920, the service platform processes the payment. In case of advertising spending, the service platform can transfer the payment to an advertising platform. At least a part of processing corresponds to determining what percentage of the payment would be used toward compensation of end users. In one aspect, end users can be compensated as part of a loyalty program, a promotional program, a branding-awareness effort, or in exchange for the user conveying its intent to the service platform when requesting a service, or a combination thereof. It should be appreciated that an advertiser making an advertising spending payment to the service platform can also be compensated as part of an advertiser retention program, or in return for the advertiser adopting a specific business model or practice proposed by the service platform [e.g., switching from a cost-per-click (CPC) to a cost-per-action (CPA) billing scheme for online advertising]. In act 930 the service platform allocates a fraction (percentage) of the payment to be used to compensate users. In case the service platform subsidizes a compensation mechanism, the effective fraction would be larger than one (or 100%). The service platform can consider subsidizing a compensation mechanism in order to gain market penetration of a business model that relies in such compensation.

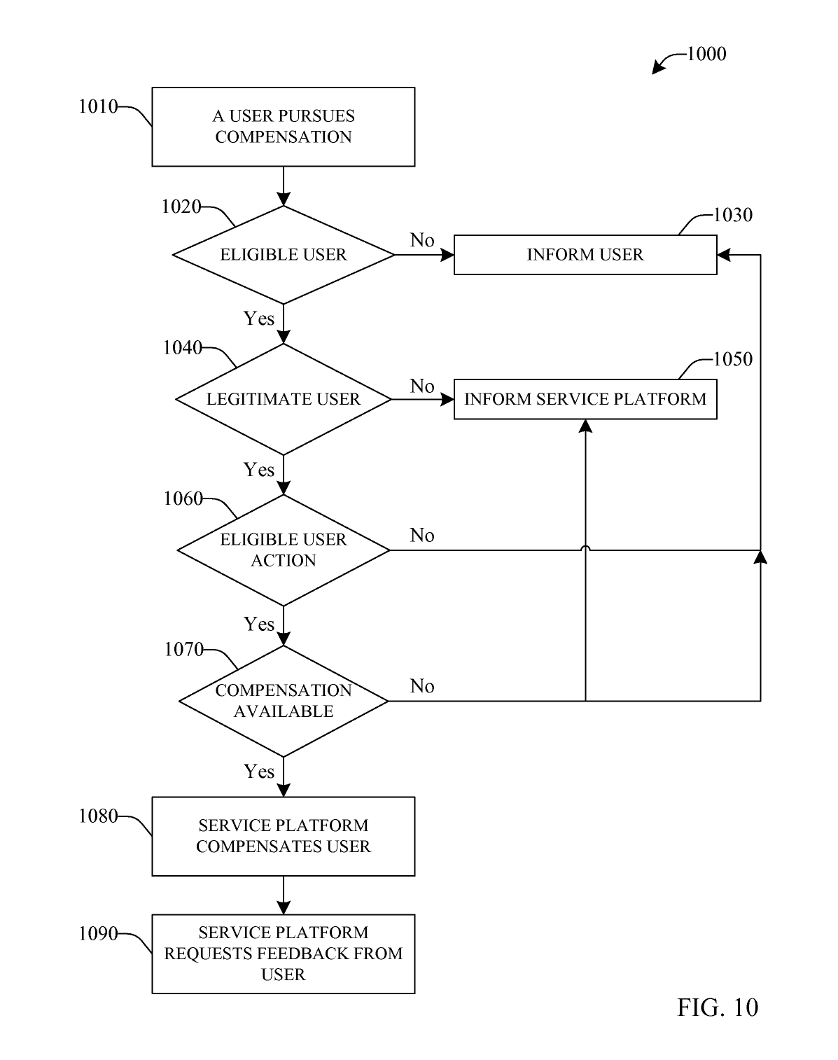

FIG. 10 presents a computer-implemented method 1000 to compensate a user of a service platform. Such a method can complement method 900 (FIG. 9). In act 1010 a user pursues compensation from a service platform. In one aspect, the service platform can present the user with advertisements that offer rebates; the advertisement either presents a rebate flag or an exact rebate value (FIG. 3). In other aspect, a previously compensated user can return to the service platform to “cash out” previous compensation in the form of compensation points. Acts 1020 and 1040 validate, respectively, eligibility and legitimacy of users who pursue compensation. It should be appreciated that an eligible user, e.g., a user registered in the intent-compensation program of the service platform or satisfying other predetermined metrics, can still attempt to obtain fraudulent compensation by misrepresenting intent or forfeiting previous compensation (e.g., specific compensation points). For example, a registered user can submit intent using a software script or can purse compensation with hacked tokens (for example, a point-token with a forfeit expiration date). In case user is not eligible for compensation he/she is informed accordingly at 1030. In case fraudulent activity is detected, the service platform is informed at 1050. Informing the service platform has the objective of investigating or penalizing user, or a combination thereof. Act 1060 consists of checking the user is pursuing compensation through an eligible action. An eligible action can be purchasing a product advertised in the service platform. But it should be appreciated that other actions can be determined to be eligible by the service platform or an advertiser. Act 1070 consists of checking whether the compensation pursued by the user is available. Several aspects can lead to a compensation not being available such as the following. (i) Funds available to an advertiser for an instant rebate or direct payment are not sufficient to compensate the user. (ii) A digital good offered to a user as compensation by a service platform or advertisement platform cannot be downloaded because a server is down for maintenance. (iii) A banking component that is part of a compensation component (222, FIG. 3) is unable to complete a direct payment. Successful checks lead to act 1080, in which the service platform compensates the user. Compensation can be issuance of compensation points, an instant rebate, or a direct payment. Points and direct payments are transferred to the user's compensation accounts. In one aspect, issued generic compensation points can be converted to monies at the checkout process in a purchase of a product at the service platform. In such a case, the service platform or a retailer would convert points at a predetermined rate, and the product's sale price would be discounted accordingly. It should be appreciated that points previously issued to the user can be used toward the purchase, thus enhancing the value of the compensation being pursued by the user. At 1090 the service platform requests the user feedback on user experience of the compensation process, or the compensation itself and its provider. Such feedback can be used to improve service provided by the platform service, to improve quantity and quality of compensation delivered, or to rate the entity responsible for providing the compensation (e.g., an advertiser, a manufacturer, a retailer).

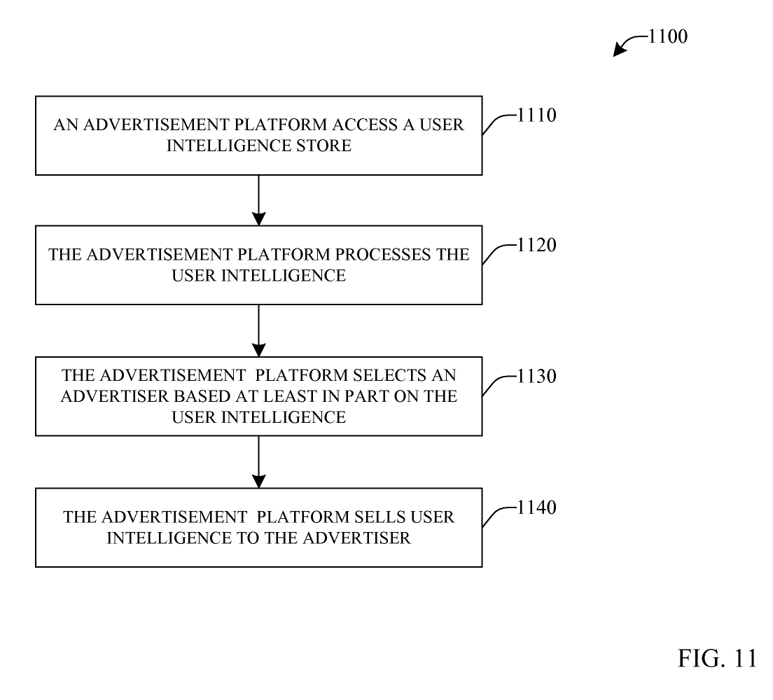

FIG. 11 depicts a computer-implemented method to select an advertiser from a pool of advertisers in order to increase value for a user and the advertiser. In act 1110 an advertisement platform accesses a user intelligence store. The access can be accomplished through a partner service platform, or by acquiring user intelligence from a specialized third-party (e.g., a broker of user intelligence). At 1120, the advertisement platform processes the user intelligence, searching for (i) patterns of user behavior such as compulsive spending; (ii) users that are price sensitive or insensitive, or have a specific socioeconomic profile, or belong to a specific ethnic background. In one aspect, by using artificial intelligence (e.g., by employing an AI component such as 228, FIG. 3) the advertisement platform can automatically process massive amounts of information. At 1130 the advertisement platform selects an advertiser based at least in part on the user intelligence. Such selection facilitates matching high-value audience (user) with suitable advertisers, thus increasing the value for the user and advertiser. At 1140, the advertisement platform sells the user intelligence to the advertiser.

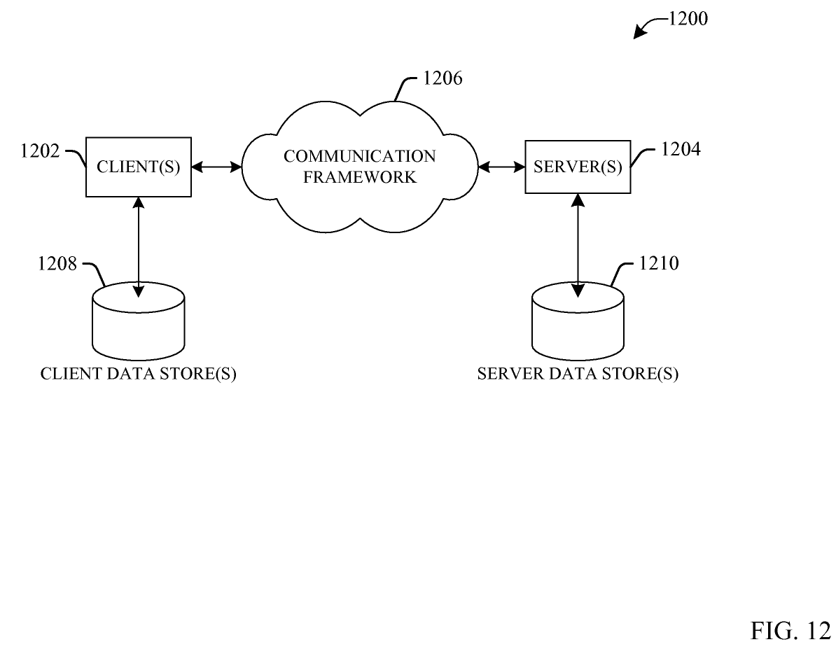

FIG. 12 illustrates a schematic block diagram of a computing environment 1200 in accordance with the subject specification. The system 1200 includes one or more client(s) 1202. The client(s) 1202 can be hardware and/or software (e.g., threads, processes, computing devices). The client(s) 1202 can house cookie(s) and/or associated contextual information by employing the specification, for example.

The system 1200 also includes one or more server(s) 1204. The server(s) 1204 can also be hardware and/or software (e.g., threads, processes, computing devices). The servers 1204 can house threads to perform transformations by employing the specification, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

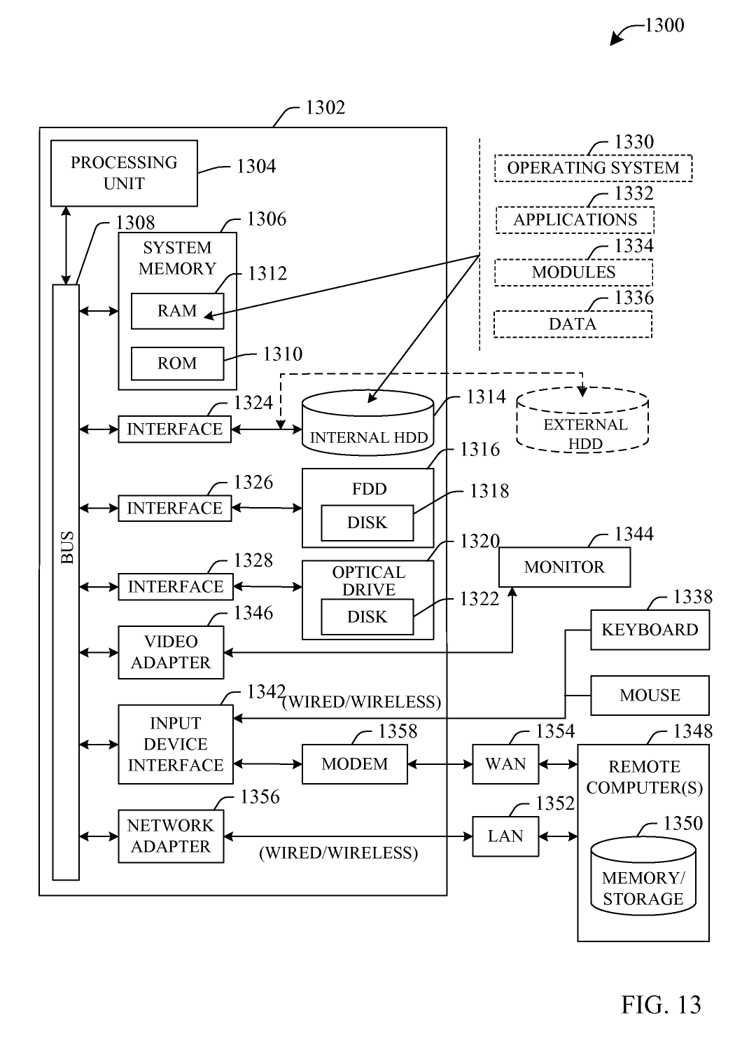

FIG. 13 illustrates a block diagram of a computer operable to execute the disclosed architecture. In order to provide additional context for various aspects of the subject specification, FIG. 13 and the following discussion are intended to provide a brief, general description of a suitable computing environment 1300 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

In FIG. 13, the example environment 1300 for implementing various aspects of the specification includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is appreciated that the specification can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device is also connected to the system bus 1308 via an interface, such as a video adapter 1346. In addition to the monitor 1344, a computer typically includes other peripheral output devices (not shown), such as speakers, printers, etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adapter 1356 may facilitate wired or wireless communication to the LAN 1352, which may also include a wireless access point disposed thereon for communicating with the wireless adapter 1356.

When used in a WAN networking environment, the computer 1302 can include a modem 1358, or is connected to a communications server on the WAN 1354, or has other means for establishing communications over the WAN 454, such as by way of the Internet. The modem 1358, which can be internal or external and a wired or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are example and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer system that compensates a user of a service platform in return for the user's intent through advertising spending, comprising:
an advertisement platform receives a subset of advertisement funds from an advertiser associated with the service platform, shares intent information of user(s) to the advertiser, and allocates a portion of the advertisement funds to compensate one or more users for sharing respective intent information; and
a compensation account that stores the portion of advertisement funds to compensate the user, and retains transactional records between the advertiser and the advertising platform.

2. The system of claim 1, the funds comprising compensation points and monetary instruments.

3. The system of claim 1, further comprising an accounting component that employs an algorithm to determine level of funding to allocate for compensating the user and a paying a commission to the service platform.

4. The system of claim 2, the compensation points being generic or specific, with generic points useful to obtain a variety of products or services, and specific points useful to obtain a specific product or service.

5. The system of claim 2, the compensation points being perishable or perennial, with perishable points valid for a determined period of time and perennial points valid at all times.

6. The system of claim 2, the compensation points being useful to obtain services or products through online and offline service platforms.

7. The system of claim 1, the advertising platform further comprising a compensation component that issues compensation points, makes direct payments and processes rebates.

8. The system of claim 1, the advertisement platform comprising a display component that renders advertisements in media.

9. The system of claim 1, the advertisement platform comprising an antifraud component that legitimizes a user's compensation.

10. The system of claim 9, the antifraud component secures the funds and transactional records in the compensation account.

11. The system of claim 1, the advertisement platform collects intelligence on the user upon compensation.

12. The system of claim 1, the advertisement platform collects user intelligence from a user-intelligence database.

13. The system of claim 11, further comprising a component that infers desirable advertisers based on the collected user intelligence.

14. A computer-implemented method that facilitates compensating a user of a service platform comprising
conveying the user's intent to the service platform, and processing the user's intent;
selling the user's intent to an advertiser; and
compensating the user with a portion of revenues received from the advertiser.

15. The method of claim 14, further comprising
processing the advertiser's spending to allocate funds to compensate the user; and
collecting intelligence on the user upon being compensated, and requesting user's feedback;

16. The method of claim 15, the processing further comprising allocating a commission for the service platform.

17. The method of claim 15, the processing further comprising applying an algorithm that allocates funds to the user as a function of a percentage (p) of the advertiser's advertisement spending wherein p is a function of time and advertiser's profile.

18. A computer-implemented method that facilitates identifying an advertiser that advertises services and products that match needs of a plurality of users, comprising
collecting intelligence on respective users of the plurality of users through an advertising platform;
analyzing the collected user intelligence; and
determining or inferring a suitable advertiser and user match as a function of user needs, user intent, advertiser qualifications, and percentage of ad revenue that can be shared with the user.

19. The method of claim 18, the processing further comprising segmenting the user intelligence according to the plurality of users' behavior patterns or socioeconomic characteristics, or a combination thereof.

20. The method of claim 18, comprising introducing the user and advertiser.
